(19) United States
(12) Patent Application Publication
(10) Pub. No.: US 2026/0312847 A1
(43) Pub. Date: Oct. 8, 2026

(54) PROBABILISTIC SHAPING FOR FLEXIBLE SPECTRUM INTEGRATION

(71) Applicant: QUALCOMM Incorporated, San Diego, CA (US)

(72) Inventors: Pinar SEN, San Diego, CA (US); Wei YANG, San Diego, CA (US); Kianoush HOSSEINI, San Diego, CA (US); Jing JIANG, San Diego, CA (US)

(21) Appl. No.: 19/173,589

(22) Filed: Apr. 8, 2025

(51) Int. Cl. H04L 27/00; H04L 27/34

(52) U.S. Cl. CPC H04L 27/0008; H04L 27/3405

(57) ABSTRACT

This disclosure provides methods, components, devices and systems for probabilistic shaping for flexible spectrum integration (FSI). For example, a wireless device may performing probabilistic shaping for a virtual cell in an integrated spectrum channel using one or more probabilistic shaping schemes in accordance with one or more shaping parameters. The wireless device may perform probabilistic shaping for each subband (e.g., associated with a different modulation order) associated with the integrated spectrum channel. That is, the wireless device may perform probabilistic shaping to map sets of information bits to sets of constellation points in accordance with the one or more shaping parameters. The one or more shaping parameters may include multiple shaping parameters, each corresponding to respective modulation orders, or may include a single shaping parameter associated with all modulation orders. In some examples, the wireless device may receive an indication of the one or more shaping parameters.

### TECHNICAL FIELD

This disclosure relates generally to wireless communication, and more specifically to systems, devices, methods, and techniques associated with probabilistic shaping for flexible spectrum integration.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

In some wireless communications systems, a wireless device, such as a UE or network entity, may communicate in accordance with a flexible spectrum integration (FSI) approach where a single virtual cell is configured for communications via an integrated spectrum channel.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a wireless device is described. The method may include receiving an indication of information for an integrated spectrum channel of a virtual cell, the integrated spectrum channel including a set of subbands that are formed by combining frequency resources from multiple frequency bands, where the set of subbands includes at least a first subband associated with a first modulation order and a second subband associated with a second modulation order different from the first modulation order, receiving an indication of one or more shaping parameters that each correspond to a respective non-uniform distribution of a respective set of constellation points, where the one or more shaping parameters are based on the first modulation order being different from the second modulation order, performing, in accordance with the one or more shaping parameters, probabilistic shaping to map a first set of information bits associated with the first subband to a first set of constellation points and to map a second set of information bits associated with the second subband to a second set of constellation points, and transmitting, via the set of subbands in the integrated spectrum channel, a single transport block, the single transport block being generated based on the first set of information bits being mapped to the first set of constellation points and the second set of information bits being mapped to the second set of constellation points.

A wireless device for wireless communications is described. The wireless device may include a processing system that includes processor circuitry and memory circuitry that stores code. The processing system may be configured to cause the wireless device to receive an indication of information for an integrated spectrum channel of a virtual cell, the integrated spectrum channel including a set of subbands that are formed by combining frequency resources from multiple frequency bands, where the set of subbands includes at least a first subband associated with a first modulation order and a second subband associated with a second modulation order different from the first modulation order, receive an indication of one or more shaping parameters that each correspond to a respective non-uniform distribution of a respective set of constellation points, where the one or more shaping parameters are based on the first modulation order being different from the second modulation order, perform, in accordance with the one or more shaping parameters, probabilistic shaping to map a first set of information bits associated with the first subband to a first set of constellation points and to map a second set of information bits associated with the second subband to a second set of constellation points, and transmit, via the set of subbands in the integrated spectrum channel, a single transport block, the single transport block being generated based on the first set of information bits being mapped to the first set of constellation points and the second set of information bits being mapped to the second set of constellation points.

Another wireless device for wireless communications is described. The wireless device may include means for receiving an indication of information for an integrated spectrum channel of a virtual cell, the integrated spectrum channel including a set of subbands that are formed by combining frequency resources from multiple frequency bands, where the set of subbands includes at least a first subband associated with a first modulation order and a second subband associated with a second modulation order different from the first modulation order, means for receiving an indication of one or more shaping parameters that each correspond to a respective non-uniform distribution of a respective set of constellation points, where the one or more shaping parameters are based on the first modulation order being different from the second modulation order, means for performing, in accordance with the one or more shaping parameters, probabilistic shaping to map a first set of information bits associated with the first subband to a first set of constellation points and to map a second set of information bits associated with the second subband to a second set of constellation points, and means for transmitting, via the set of subbands in the integrated spectrum channel, a single transport block, the single transport block being generated based on the first set of information bits being mapped to the first set of constellation points and the second set of information bits being mapped to the second set of constellation points.

A non-transitory computer-readable medium storing code for wireless communications is described. The code may include instructions executable by one or more processors to receive an indication of information for an integrated spectrum channel of a virtual cell, the integrated spectrum channel including a set of subbands that are formed by combining frequency resources from multiple frequency bands, where the set of subbands includes at least a first subband associated with a first modulation order and a second subband associated with a second modulation order different from the first modulation order, receive an indication of one or more shaping parameters that each correspond to a respective non-uniform distribution of a respective set of constellation points, where the one or more shaping parameters are based on the first modulation order being different from the second modulation order, perform, in accordance with the one or more shaping parameters, probabilistic shaping to map a first set of information bits associated with the first subband to a first set of constellation points and to map a second set of information bits associated with the second subband to a second set of constellation points, and transmit, via the set of subbands in the integrated spectrum channel, a single transport block, the single transport block being generated based on the first set of information bits being mapped to the first set of constellation points and the second set of information bits being mapped to the second set of constellation points.

In some examples of the method, wireless devices, and non-transitory computer-readable medium described herein, receiving the indication of the one or more shaping parameters may include operations, features, means, or instructions for receiving an indication of a modulation and coding scheme table associated with the set of subbands, where the modulation and coding scheme table includes an indication of one or more associations between the first modulation order, the second modulation order, or both, and the one or more shaping parameters.

In some examples of the method, wireless devices, and non-transitory computer-readable medium described herein, the one or more shaping parameters include a first shaping parameter associated with the first modulation order and a second shaping parameter associated with the second modulation order and the first shaping parameter may be different from the second shaping parameter based on the first modulation order being different from the second modulation order. In some examples of the method, wireless devices, and non-transitory computer-readable medium described herein, the one or more shaping parameters include a joint shaping parameter associated with the first modulation order and the second modulation order.

### BRIEF DESCRIPTION OF THE DRAWINGS

FIG. 1 shows an example of a wireless communication system.

FIG. 2 shows an example of a signaling configuration that supports probabilistic shaping for flexible spectrum integration (FSI).

FIGS. 3-6 show examples of probabilistic shaping schemes that support probabilistic shaping for FSI.

FIG. 7 shows an example of a process flow that supports probabilistic shaping for FSI.

FIG. 8 shows a block diagram of a processing system that supports probabilistic shaping for FSI.

FIG. 9 shows a diagram of a system including a device that supports probabilistic shaping for FSI.

FIG. 10 shows a flowchart illustrating methods that support probabilistic shaping for FSI.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, wireless devices, such as a user equipment (UE) or a network entity, may communicate via a single virtual cell in an integrated spectrum channel (e.g., in accordance with a flexible spectrum integration (FSI) approach). The integrated spectrum channel may be formed by combining frequency resources from multiple frequency bands into a set of subbands. Each subband may generally include a subset of frequency resources within a physical carrier, a single physical carrier, or multiple physical carriers. Accordingly, a transmitting device may obtain or otherwise identify an indication of the integrated spectrum channel of the single virtual cell, may obtain a grant that schedules communications with a receiving wireless device in the subbands of the integrated spectrum channel, and may generate a single transport block (TB) for transmitting the data to the receiving wireless device over the set of subband(s) of the integrated spectrum channel.

Additionally, or alternatively, some wireless devices may use probabilistic shaping to transmit one or more signals. Probabilistic shaping may generate non-uniformly distributed modulation symbols, which may further improve the spectral efficiency of a transmission compared to uniformly distributed modulation symbols at the same modulation order. It may be desirable to perform probabilistic shaping for communications using an FSI approach (e.g., to obtain the benefits of each). However, when each subband (e.g., at least one subband) of the set of subbands of the integrated spectrum channel is associated with a different modulation order, the transmitting wireless device may be unable to determine how to perform probabilistic shaping across the set of subbands (e.g., performing probabilistic shaping across multiple subbands with differing modulation orders may be undefined in current systems).

Aspects of the subject matter described in this disclosure relate to a wireless device performing probabilistic shaping for FSI using one or more probabilistic shaping schemes. For example, the wireless device may receive an indication of information of the integrated spectrum channel (e.g., information of the FSI) and an indication of one or more shaping parameters. The wireless device may perform probabilistic shaping for each modulation order (e.g., associated with a respective subband of the set of subbands) indicated in the information of the integrated spectrum channel in accordance with the one or more shaping parameters. That is, the wireless device may perform probabilistic shaping to map sets of information bits to sets of constellation points in accordance with a respective shaping parameter for each modulation order (e.g., each subband), or in accordance with a joint shaping parameter for all modulation orders.

For example, the wireless device may use a different (e.g., respective) shaping parameter for each modulation order (e.g., each subband) and may perform probabilistic shaping separately for each set of constellation points associated with each modulation order in accordance with a respective shaping parameter. In a second example, the wireless device may use a joint shaping parameter associated with all modulation orders (e.g., associated with all subbands in the set of subbands) and may perform probabilistic shaping separately for each set of constellation points associated with each modulation order in accordance with the joint shaping parameter. In another example, the wireless device may apply a largest modulation order across all subbands and may perform probabilistic shaping separately for each set of constellation points associated with each subband using a respective shaping parameter for each subband. In a fourth example, the wireless device may perform probabilistic shaping jointly across the set of subbands in accordance with a joint shaping parameter.

In some examples, the wireless device may receive an indication of the one or more shaping parameters. For example, the wireless device may receive an indication of a modulation and coding scheme (MCS) table, where respective entries of the table are associated with respective shaping parameters.

Particular aspects of the subject matter described in this disclosure can be implemented to realize one or more of the following potential advantages. In some examples, by enabling the wireless device to perform probabilistic shaping for different modulation orders and subbands, the described techniques can be used to transmit probabilistically shaped TB using a virtual cell in an integrated spectrum channel, which may increase a likelihood a receiving wireless device successfully decodes the TB.

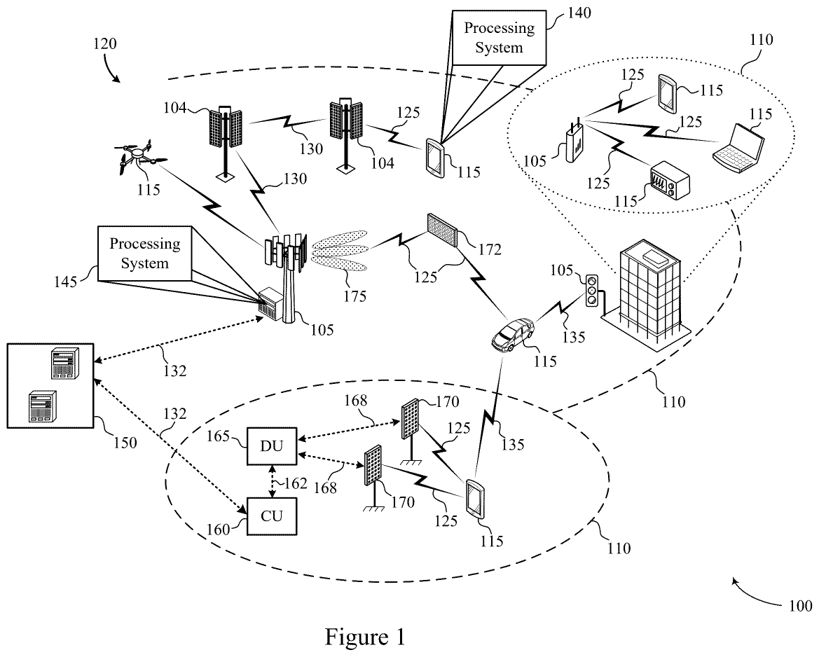

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or both to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for probabilistic shaping for flexible spectrum integration. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support probabilistic shaping that maps sets of information bits to sets of constellation points in accordance with one or more shaping parameters for differing modulation orders and subbands. Performing probabilistic shaping for different modulation orders (e.g., for each subband) may enable the UE 115 to transmit a probabilistically shaped TB using a virtual cell in an integrated spectrum channel, which may be associated with increased channel diversity and shaping gain.

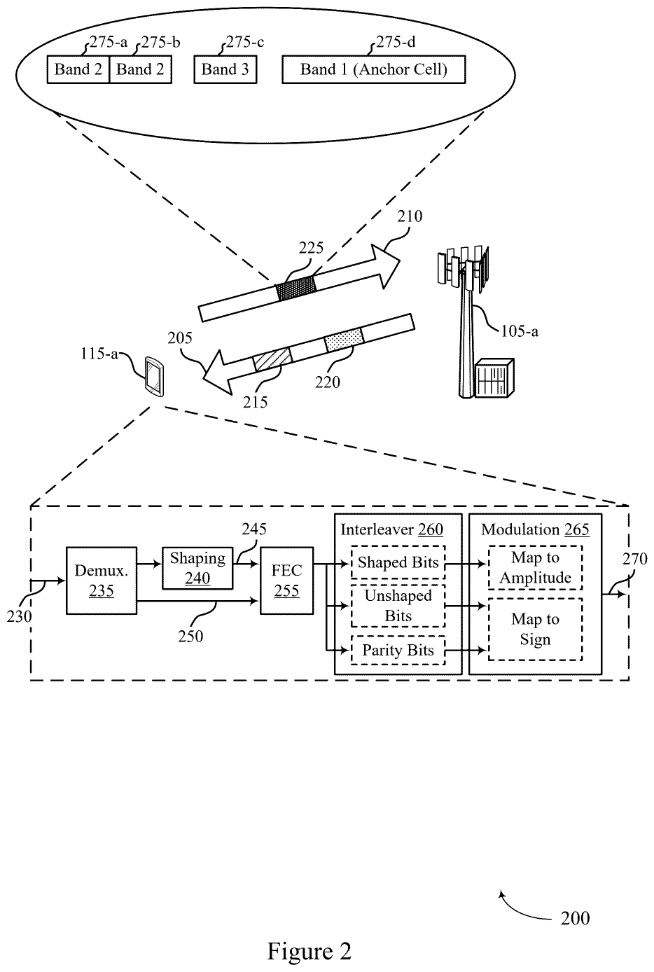

FIG. 2 shows an example of a signaling configuration 200 that supports probabilistic shaping for FSI. The signaling configuration 200 may implement or be implemented by aspects of the wireless communication system 100. For example, the signaling configuration 200 may include a UE 115-a and a network entity 105-a, which may be examples of the corresponding devices described herein, including with reference to FIG. 1. The UE 115-a may receive downlink communications via a downlink channel 205 between the UE 115-a, and the network entity 105-a may transmit uplink communications via an uplink channel 210 between the UE 115-a and the network entity 105-a.

In some examples, the UE 115-a and the network entity 105-a may communicate using an FSI approach. Broadly, the FSI approach may include mixing and matching frequency resources from different frequency bands to form a virtual cell (e.g., to support single-cell operations). In the non-limiting example shown in FIG. 2, this may include the virtual cell including an integrated spectrum channel formed using a set of subbands 275, where the set of sub-bands 275 are formed by combining frequency resources from multiple frequency bands. For example, a subband 275-a and a subband 275-b may be formed using frequency resources from frequency band 2 (e.g., Band 2), a subband 275-c may be formed using frequency resources from frequency band 3 (e.g., Band 3), and a sub-band 275-d may be formed using frequency resources from frequency band 1 (e.g., Band 1). Accordingly, each sub-band 275 in the set of sub-bands 275 include a subset of frequency resources within a physical carrier, a single physical carrier, or multiple physical carriers within the corresponding frequency band. Frequency band 1 may generally be associated with or otherwise designated as an anchor cell (e.g., associated with scheduling wireless communications for the virtual cell).

In some aspects, the UE 115-a may receive, or otherwise obtain, an indication 215 of information (e.g., configuration information) for the integrated spectrum channel. For example, the network entity 105-a may transmit or otherwise output the indication 215. The network entity 105-a, in this example, may obtain the information for the integrated spectrum channel by forming, selecting, or otherwise allocating the information and then providing the information to the UE 115-a via the indication 215. The UE 115-a may receive the indication 215 via the downlink channel 205 or via other (pre) configured information associated with the network entity 105-a.

Accordingly, a single TB 225 (e.g., for downlink communications when the network entity 105-a is the transmitting device or for uplink communications when the UE 115-a is the transmitting device) may be scheduled over the set of non-contiguous frequency resources (e.g., over the integrated spectrum channel). A non-contiguous BWP may be configured that spans over a set of aggregated frequency resources across different physical channels. Additionally, or alternatively, separate BWPs may be configured on different subbands where the single TB 225 is scheduled across the different subbands. In the uplink example, for CP-OFDM, the single TB 225 may be mapped to multiple non-contiguous chunks of the frequency spectrum. In the uplink example, for DFT-S-OFDM, there may be some peak-average-power ratio (PAPR) considerations regarding non-contiguous frequency resource mapping. If the UE 115-a includes multiple power amplifiers that are each connected to one contiguous segment, the single TB 225 may be mapped to a non-contiguous set of frequency resources without PAPR impacts.

Communicating a single TB 225 over the integrated spectrum channel may support additional diversity in lower frequency bands (e.g., small FDD bands). This may support a single-component carrier (CC) control channel element (CCE)/blind decoding operation of the UE 115-a. Different from carrier aggregation (CA) techniques, the FSI approach does not involve scaling up the PDCCH load with the quantity of CCs (e.g., due to the anchor cell), thereby significantly reducing UE power consumption. This may provide additional bandwidth adaptations using BWP mechanisms, which may be less complex and resource-intensive than secondary cell addition, release, activation, and deactivation mechanisms associated with CA techniques.

In some cases, wireless devices like the UE 115-a, the network entity 105-a, or both, may support constellation shaping. In other words, a transmitting wireless device, such as the UE 115-a or the network entity 105-a, may map a set of information bits to a set of constellation points, and in some cases, may modify a distribution (e.g., mapping) of the set of information bits to the set of constellation points such that more information bits may be mapped to some constellation points compared to other constellation points. The modification of the distribution may be referred to as probabilistic shaping (also referred to as inverse source coding, where uniformly distributed bits may be compressed into non-uniformly distributed bits). In some examples, the probabilistic shaping may be associated with a target distribution, a target transmit power (e.g., minimal transmit power), or both. For example, the constellation may be shaped to have Gaussian-like bits or amplitudes. That is, the inner symbols of a constellation may be associated with a higher probability than outer symbols of the constellation (e.g., which may resemble a Gaussian distribution).

In some examples, a wireless device (e.g., the UE 115-a, the network entity 105-a, or both) may perform probabilistic shaping in accordance with a Maxwell-Boltzmann distribution described in Equation 1:

$$p ( x ) ∼ {e}^{- v {\vert x \vert}^{2}} \qquad ( 1 )$$

where p(x) is a probability of a symbol, x, in a constellation and v is the shaping parameter. The probability of a respective symbol, x, to occur in the constellation may be inversely proportional to its energy (e.g., higher energy symbols may appear less frequent than lower energy symbols, which may increase a shaping gain). In some cases, the Maxwell-Boltzmann distribution may maximize source entropy for a given average power. Probabilistic shaping may be performed using a variety of source coding techniques. For example, probabilistic shaping may be performed using constant-composition distribution matcher (CCDM) or arithmetic coding, Huffman codes, sphere shaping, channel codes (e.g., polar, low-density generator matrix (LDGM), convolutional, trellis coded modulation (TCM)), and the like.

In an example, the UE 115-a may input a set of uniform information bits 230 into a demultiplexor block 235. The demultiplexor block 235 may separate the information bits 230 multiple subsets of bits. For example, the demultiplexor block 235 may output a first subset of the information bits 230 to a shaping block 240 (e.g., that includes one or more distribution measure (DM) blocks). The demultiplexor block 235 may output a second subset of the information bits, also referred to as unshaped bits 250, to a forward error-correcting code (FEC) 255. The shaping block 240 may output shaped bits 245 to the FEC 255 based on shaping the first subset of the information bits 230 in accordance with Equation 1. An interleaver block 260 may interleave each of the shaped bits 245, unshaped bits 250, and parity bits associated with the information bits 230. A modulation block 265 may map the shaped bits 245 to one or more amplitude bit levels and map the unshaped bits 250 and parity bits to one or more sign bit levels. The modulation block 265 may output a set of modulated symbols 270 to be transmitted over the uplink channel 210.

Communicating using the FSI approach may improve the quality of uplink and downlink transmissions between the UE 115-a and the network entity 105-a because transmitting a single TB 225 using multiple subbands 275, each with different channel qualities, may increase a resource diversity gain of the transmission. In some cases, the gain of single TB 225 may be based on the fact that, with proper interleaving, each CB (e.g., associated with the single TB 225) may be mapped to different sub-bands 275 and, thus, experience different channel conditions. Communicating using probabilistically-shaped transmissions may also be desirable because of the associated shaping gain of the non-uniform constellation. However, when the different subbands 275 used in the FSI approach are associated with different modulation orders (e.g., QAM), different ranks, or both, the UE 115-a (e.g., the transmitting wireless device) may be unable to determine how to perform probabilistic shaping across the different subbands 275 (e.g., current systems do not address performing probabilistic shaping across different modulation orders).

The techniques described herein enable a wireless device (e.g., the UE 115-a, the network entity 105-a, or both) to perform probabilistic shaping for the FSI approach using one or more probabilistic shaping schemes. For example, the UE 115-a may receive the indication 215 of the FSI information (e.g., configuration information associated with an integrated spectrum channel) as well as an indication 220 of one or more shaping parameters. In some cases, the indication 215 of the FSI information may include the indication 220 of the one or more shaping parameters. In some other cases, the UE 115-a may receive the indication 215 of the one or more shaping parameters via an indication of one or more MCS tables. For each subband 275 (e.g., of a set of subbands 275 associated with the integrated spectrum channel), the UE 115-a may perform probabilistic shaping to map sets of information bits to sets of constellation points in accordance with the one or more shaping parameters and the one or more probabilistic shaping schemes. Based on mapping the sets of information bits to the sets of constellation points, the UE 115-a may transmit the single TB 225.

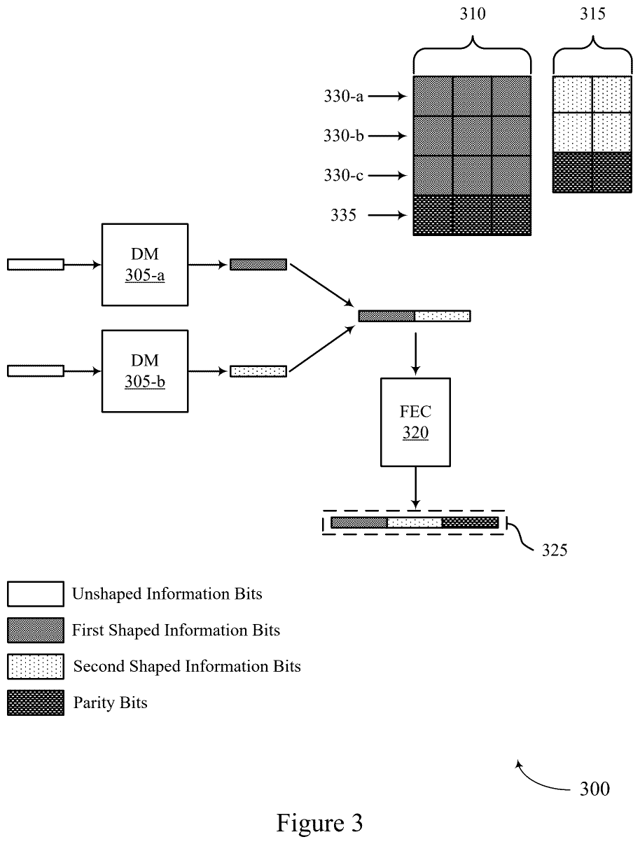

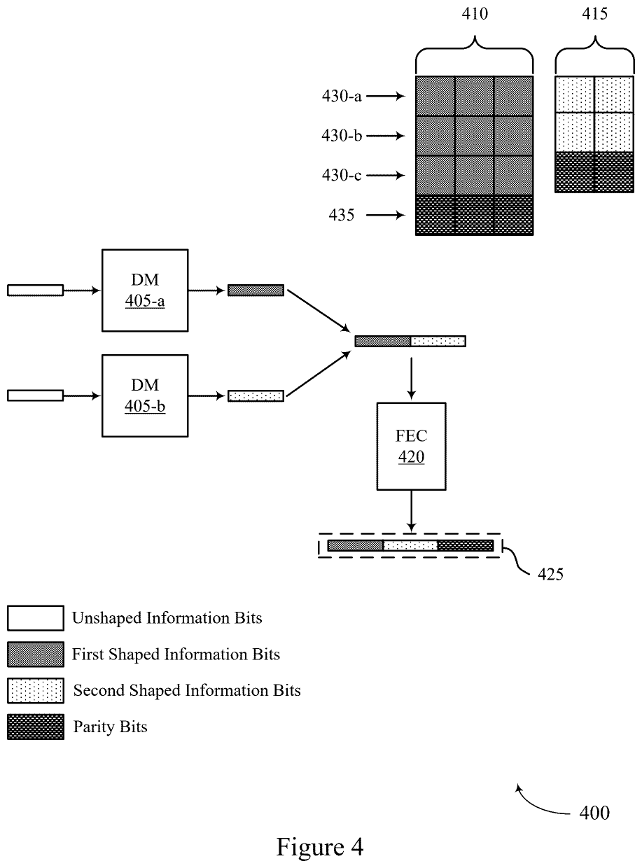

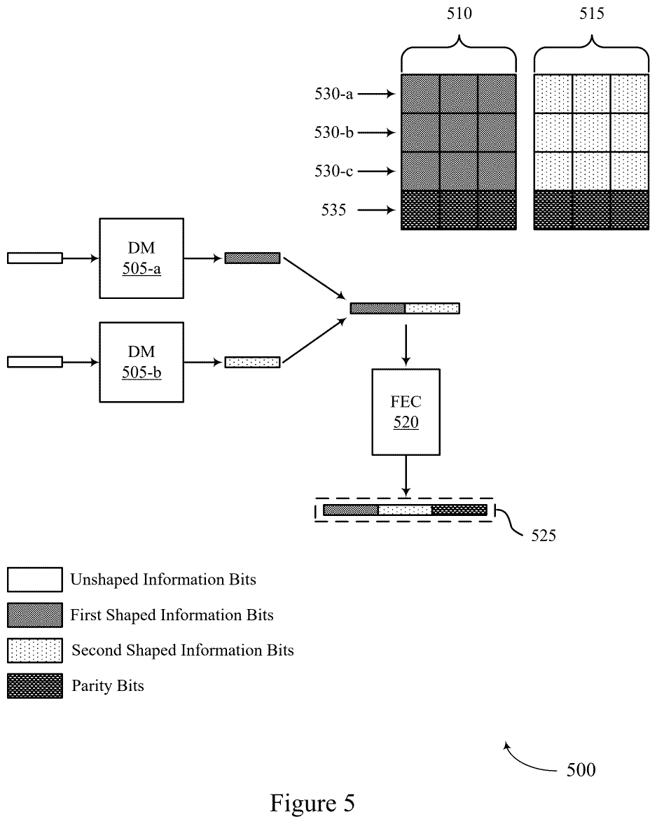

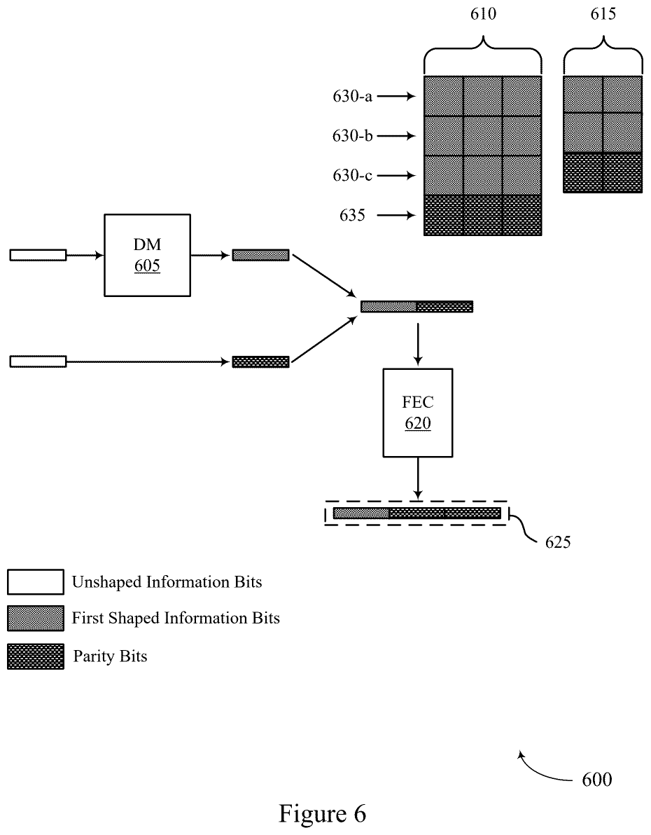

In a first example probabilistic shaping scheme, the UE 115-a may perform probabilistic shaping separately for each modulation order (e.g., QAM) associated with the set of subbands 275 (e.g., indicated in the indication 215) using a respective (e.g., different) shaping parameter, as described with reference to FIG. 3. In some cases, each shaping parameter may be signaled separately. In another example shaping scheme, the UE 115-a may perform probabilistic shaping separately for each modulation order (e.g., using separate shaping blocks) using a same, or joint, shaping parameter associated with all modulation orders, as described with reference to FIG. 4. That is, while a single shaping parameter may be signaled, the UE 115-a may generate different shaping distributions for different modulation orders (e.g., sizes) using the single shaping parameter. In a third example probabilistic shaping scheme, the UE 115-a may apply a largest modulation order associated with the set of subbands 275 to each subband 275 and perform probabilistic shaping separately for each subband 275 using a respective shaping parameter, as described with reference to FIG. 5. For example, for a subband 275 associated with a lower modulation order than the largest modulation order, the shaping parameter may suppress outer symbols of a constellation associated with the subband 275 to approximate its lower modulation order. In a fourth example scheme, the UE 115-a may use a joint shaping parameter of different bit levels of modulation orders (e.g., sizes) throughout the subbands 275 (e.g., the UE 115-a may shape one or more bits across all modulation orders of the subbands 275 using a single shaping block and the remaining bits in each modulation order may be unshaped), as described with reference to FIG. 6.

In some examples, the UE 115-a may dynamically switch between each of the probabilistic shaping schemes. For example, the UE 115-a may determine to use a different probabilistic shaping scheme based on a quantity of subbands, a size of the single TB 225, or both. In some examples, the UE 115-a may transmit, to the network entity 105-a, an indication of which probabilistic shaping scheme was used by the UE 115-a, such that the network entity 105-a may receive the indication and decode the single TB 225 based on the indicated probabilistic shaping scheme). The single TB 225 may include the indication of the probabilistic shaping scheme. In another example, the UE 115-a may indicate which probabilistic shaping scheme was used in a separate transmission. Additionally, or alternatively, the network entity 105-a may indicate the UE 115-a to use a respective probabilistic shaping scheme. In some examples, the indication 215 of the FSI information or the indication 220 of the one or more shaping parameters, or both, may include an indication of which probabilistic shaping scheme to use for transmitting the single TB 225. By enabling the UE 115-a to perform probabilistic shaping for communications using an FSI approach, the described techniques may enable the UE 115-a to experience benefits of both the FSI approach and probabilistic shaping, such an increase in channel diversity and shaping gain for transmissions, among other examples.

FIG. 3 shows an example of a probabilistic shaping scheme 300 that supports probabilistic shaping for FSI. The probabilistic shaping scheme may implement or be implemented by aspects of the wireless communication system 100 or the signaling configuration 200. For example, a wireless device (e.g., a UE 115, a network entity 105) may perform probabilistic shaping for two or more subbands in accordance with the probabilistic shaping scheme 300. The wireless device may map a first set of information bits associated with a subband 310 to a first set of constellation points and map a second set of information bits associated with a subband 315 to a second set of constellation points in accordance with one or more shaping parameters (e.g., the first set of information bits and the second set of information bits may correspond to a single TB). The subband 310 may be associated with a first modulation order (e.g., with three amplitude bit levels 330-a, 330-b, and 330-c and a sign bit level 335) and the subband 315 may be associated with a second modulation order (e.g., with two amplitude bit levels 330-a and 330-b and a sign bit level 335), where the first modulation order is different than the second modulation order.

In the probabilistic shaping scheme 300, the wireless device may use a different shaping parameter for each modulation order (e.g., of a set of modulation orders) associated with the subbands (e.g., the subband 310 and the subband 315). In some examples, there may be separate shaping parameters for each QAM size (e.g., modulation order) and may achieve a Maxwell-Boltzmann distribution. For example, the wireless device may input first unshaped information bits into a DM 305-a and input second unshaped information bits into a DM 305-b. Each of the DMs 305 may be included in a respective shaping block 240 described with reference to FIG. 2, and the first and second unshaped information bits may be associated with an output of demultiplexor block 235 (e.g., each modulation order is associated with a separate shaping block 240). The DM 305-a may correspond to the first modulation order and the DM 305-b may correspond to the second modulation order.

The DM 305-a may shape the first unshaped information bits (e.g., of length

$${K}_{1}^{′} )$$

into first shaped information bits (e.g., of length K₁) in accordance with a first shaping parameter, and DM 305-b may shape the second unshaped information bits (e.g., of length

$${K}_{2}^{′} )$$

into the second shaped information bits (e.g., of length K₂) in accordance with a second shaping parameter. That, is the DM 305-a may receive the first unshaped information bits and may map the first unshaped information bits to the first set of constellation points to generate the first shaped information bits, where the first set of constellation points is associated with a first non-uniform distribution (e.g., first MB distribution) in accordance with a first shaping parameter (e.g., a first shaping parameters, v₁, as described with reference to Equation 1). Similarly, the DM 305-b may receive the second unshaped information bits and may map the second unshaped information bits to the second set of constellation points to generate the second shaped information bits, where the second set of constellation points is associated with a second non-uniform distribution (e.g., second MB distribution) in accordance with a second shaping parameter (e.g., a second shaping parameters, v₂, as described with reference to Equation 1). As described previously, the first shaping parameter may be different than the second shaping parameter based on the first modulation order (e.g., associated with the subband 310) being different than the second modulation order (e.g., associated with the subband 315). That is, the first shaping parameter may correspond to the first modulation order and the second shaping parameter may correspond to the second modulation order.

Although two DMs 305 are illustrated in FIG. 3, it is to be understood that the wireless device may include any quantity of DMs 305 for shaping any quantity of modulation orders (e.g., subbands) associated with an FSI approach for wireless communications. That is, each subband (e.g., modulation order) may be associated with a DM 305, such that a quantity of subbands associated with an integrated spectrum channel may correspond to a quantity of DMs 305 (e.g., where each DM 305 is associated with a respective shaping parameter).

The wireless device may input the first shaped information bits and the second shaped information bits into the FEC 320 (e.g., the FEC 255) to obtain a set 325 of first shaped information bits, second shaped information bits, and one or more parity bits. In some examples, the set 325 may be input into an interleaver block (e.g., the interleaver block 260) and then a modulation block (e.g., a modulation block 265) to obtain a set of modulated symbols to be transmitted.

In some examples, the first shaping parameter and the second shaping parameter may each be signaled to the wireless device separately. Each shaping parameter may be associated with an MCS table. For example, a respective shaping parameter may correspond to a respective entry of the MCS table. Different MCS values may be signaled for different subbands.

FIG. 4 shows an example of a probabilistic shaping scheme 400 that supports probabilistic shaping for FSI. The probabilistic shaping scheme may implement or be implemented by aspects of the wireless communication system 100 or the signaling configuration 200. For example, a wireless device (e.g., a UE 115, a network entity 105) may perform probabilistic shaping for two or more subbands in accordance with the probabilistic shaping scheme 400. The wireless device may map a first set of information bits associated with a subband 410 to a first set of constellation points and map a second set of information bits associated with a subband 415 to a second set of constellation points in accordance with one or more shaping parameters (e.g., the first set of information bits and the second set of information bits may correspond to a single TB). The subband 410 may be associated with a first modulation order (e.g., with three amplitude bit levels 430-a, 430-b, and 430-c and a sign bit level 435) and the subband 415 may be associated with a second modulation order (e.g., with two amplitude bit levels 430-a and 430-b and a sign bit level 435), where the first modulation order is different than the second modulation order.

In the probabilistic shaping scheme 400, the wireless device may use a joint (e.g., same) shaping parameter for all modulation orders associated with the subbands (e.g., the subband 410 and the subband 415). In some examples, the probabilistic shaping scheme 400 may provide for a coupled distribution via a single joint shaping parameter for up to all QAM sizes. For example, the wireless device may input first unshaped information bits into a DM 405-a and input second unshaped information bits into a DM 405-b. Each of the DMs 405 may be included in a respective shaping block 240 described with reference to FIG. 2, and the first and second unshaped information bits may be associated with the output of the demultiplexor block 235. The DM 405-a may correspond to the first modulation order and the DM 405-b may correspond to the second modulation order. Although two DMs 405 are illustrated in FIG. 4, it is to be understood that the wireless device may include any quantity of DMs 405 for shaping any quantity of modulation orders (e.g., subbands) associated with an FSI approach for wireless communications. That is, each subband (e.g., modulation order) may be associated with a DM 405, such that a quantity of subbands associated with an integrated spectrum channel may correspond to a quantity of DMs 405 (e.g., where each DM 405 is associated with a same shaping parameter).

The DM 405-a may shape the first unshaped information bits into (e.g., of length

$${K}_{1}^{′} )$$

first shaped information bits (e.g., of length K₁) in accordance with the joint shaping parameter. DM 405-b may also shape the second unshaped information bits (e.g., of length

$${K}_{2}^{′} )$$

into the second shaped information bits (e.g., of length K₂) in accordance with the joint shaping parameter. That, is the DM 405-a may receive the first unshaped information bits and may map the first unshaped information bits to the first set of constellation points to generate the first shaped information bits, where the first set of constellation points is associated with a first non-uniform distribution (e.g., first MB distribution) in accordance with the joint shaping parameter (e.g., a joint shaping parameters, v, as described with reference to Equation 1). Similarly, the DM 405-b may receive the second unshaped information bits and may map the second unshaped information bits to the second set of constellation points to generate the second shaped information bits, where the second set of constellation points is associated with a second non-uniform distribution (e.g., second MB distribution) in accordance with the joint shaping parameter. While both the DM 405-a and the DM 405-b may use the joint shaping parameter (e.g., the same shaping parameter), the first non-uniform distribution may be different than the second non-uniform distribution based on a modulation mapping function, ƒ^{(k)}, for each subband, k.

That is, the DMs 405 may shape the information bits in accordance with Equation 2 (e.g., in accordance with a respective MB distribution p(Sₖ)):

$${ρ}_{k} ( {S}_{k} ) ∼ {e}^{- {v [ {f}^{( k )} ( {S}_{k} ) ]}^{2}} \qquad ( 2 )$$

where ƒ^{(k)} is the real modulation mapping function for a subband, k, that maps Lₖ bits (e.g., [b₁, b₂, . . . , bₖ] where ƒ^{(k)}: {0,1}^{L}^{ₖ} [symbol] {1, 3, 5, . . . 2^{L}^{ₖ}⁺¹−1}) to a positive real number or amplitude level, where Sₖ=(b₁, b₂, . . . , bₖ) and is the sequence of Lₖ bits that are to be shaped in subband k=1, 2, . . . , n, and where v is the joint shaping parameter. In some examples, the joint shaping parameter of a probability mass function may be computed by the wireless device or by a second wireless device (e.g., that indicates the joint shaping parameter to the wireless device) based on the condition of Equation 3:

$${\sum }_{k} {ρ}_{k} {H}_{{ρ}_{k}} ( {S}_{k} ) = η , η ∈ [ 0 , K ] \qquad ( 3 )$$

where K is the largest amplitude bit level 430 across subbands and ρₖ is a ratio of a quantity of transmitted symbols in a subband k to the total quantity of transmitted symbols across all subbands. In other words, the joint shaping parameter may be computed based on maximizing the overall entropy of the transmitted information across different subbands. Because the modulation mapping function, ƒ^{(k)}, is dependent on a subband, k, the non-uniform distribution, ρₖ(Sₖ), may be different for each subband, k. In some examples, the non-uniform distribution, ρₖ(Sₖ) may be a Maxwell-Boltzmann distribution for subband k.

The wireless device may input the first shaped information bits and the second shaped information bits into the FEC 420 (e.g., the FEC 255) to obtain a set 425 of first shaped information bits, second shaped information bits, and one or more parity bits. In some examples, the set 425 may be input into an interleaver block (e.g., the interleaver block 260) and then a modulation block (e.g., a modulation block 265) to obtain a set of modulated symbols to be transmitted. In some examples, by using the joint shaping parameter (e.g., v) for the subband 410 and the subband 415, overhead signaling may be reduced (e.g., relative to other schemes that may signal multiple shaping parameters) by signaling a single parameter (e.g., v) instead of signaling multiple parameters.

FIG. 5 shows an example of a probabilistic shaping scheme 500 that supports probabilistic shaping for FSI. The probabilistic shaping scheme may implement or be implemented by aspects of the wireless communication system 100 or the signaling configuration 200. For example, a wireless device (e.g., a UE 115, a network entity 105) may perform probabilistic shaping for two or more subbands in accordance with the probabilistic shaping scheme 500. The wireless device may map a first set of information bits associated with a subband 510 to a first set of constellation points and map a second set of information bits associated with a subband 515 to a second set of constellation points in accordance with one or more shaping parameters (e.g., the first set of information bits and the second set of information bits may correspond to a single TB). The subband 510 may be associated with a first modulation order based on one or more channel conditions associated with the subband 510 (e.g., with three amplitude bit levels 530-a, 530-b, and 530-c and a sign bit level 535) and the subband 515 may be associated with a second modulation order smaller (e.g., lower) than the first modulation order based on one or more channel conditions associated with the second subband.

In the probabilistic shaping scheme 500, the wireless device may use a same modulation order with different shaping parameters for shaping transmissions for the subbands. In an example, a same QAM size may be associated with different shaping parameters. For example, despite the subband 515 being associated with a smaller modulation order based on the one or more corresponding channel conditions, the wireless device may apply the largest modulation order of all the subbands (e.g., the first modulation order) for the subband 515 (e.g., for the purpose of probabilistic shaping). However, a second shaping parameter associated with the subband 515 may suppress a shape of the constellation associated with the subband 515 such that the constellation will be associated with an effectively smaller modulation order (e.g., the second shaping parameter for the subband 515 may result in a constellation that corresponds to the second modulation order).

The wireless device may input first unshaped information bits into a DM 505-a and input second unshaped information bits into a DM 505-b. Each of the DMs 505 may be included in a respective shaping block 240 described with reference to FIG. 2, and the first and second unshaped information bits may be associated with the output of the demultiplexor block 235. Each of the DMs 505 may correspond to a largest modulation order (e.g., the first modulation order) of the subbands. Although two DMs 505 are illustrated in FIG. 5, it is to be understood that the wireless device may include any quantity of DMs 505 for shaping any quantity of modulation orders (e.g., subbands) associated with an FSI approach for wireless communications. That is, each subband (e.g., modulation order) may be associated with a DM 505, such that a quantity of subbands associated with an integrated spectrum channel may correspond to a quantity of DMs 505 (e.g., where each DM 505 is associated with a same shaping parameter).

The DM 505-a may shape the first unshaped information bits (e.g., of length K′₁) into first shaped information bits in accordance with a first shaping parameter (e.g., of length K₁), and DM 505-b may shape the second unshaped information bits (e.g., of length K₂′) into the second shaped information bits (e.g., of length K₂) in accordance with a second shaping parameter, where the first shaping parameter is different than the second shaping parameter. That, is the DM 505-a may receive the first unshaped information bits and may map the first unshaped information bits to a first set of constellation points to generate the first shaped information bits, where the first set of constellation points is associated with a first non-uniform distribution (e.g., first MB distribution) in accordance with the first shaping parameter (e.g., a first shaping parameters, v₁, as described with reference to Equation 1). Similarly, the DM 4505-b may receive the second unshaped information bits and may map the second unshaped information bits to a second set of constellation points to generate the second shaped information bits, where the second set of constellation points is associated with a second non-uniform distribution (e.g., second MB distribution) in accordance with the second shaping parameter (e.g., a second shaping parameters, v₂, as described with reference to Equation 1). As described previously, the first shaping parameter may be different than the second shaping parameter based on the first modulation order (e.g., associated with the subband 510) being different than the second modulation order (e.g., associated with the subband 515). That is, the first shaping parameter may correspond to the first modulation order and the second shaping parameter may correspond to the second modulation order.

In some examples, the DMs 505 may receive uniformly-distributed information bits and output shaped information bits using Equation 4:

$${ρ}_{k} ( S ) ∼ {e}^{- {{v}_{k} [ f ( S ) ]}^{2}} \qquad ( 4 )$$

where ƒ(S) is a real modulation mapping function (e.g., same across all subbands) that maps L bits (e.g., [b₁, b₂, . . . , bₖ] where ƒ:{0,1}^{L} [symbol] {1, 3, 5, . . . 2^{L+1}−1}) to a positive real number or amplitude level, S=(b₁, b₂, . . . , b_{L}) and is the sequence of L bits that are to be shaped, and vₖ is the shaping parameter for a subband, k. In some examples, the non-uniform distribution, ρₖ(S) may be a Maxwell-Boltzmann distribution for subband k.

The wireless device may input the first shaped information bits and the second shaped information bits into the FEC 520 (e.g., the FEC 255) to obtain a set 525 of first shaped information bits, second shaped information bits, and one or more parity bits. In some examples, the set 525 may be input into an interleaver block (e.g., the interleaver block 260) and then a modulation block (e.g., a modulation block 265) to obtain a set of modulated symbols to be transmitted.

FIG. 6 shows an example of a probabilistic shaping scheme 600 that supports probabilistic shaping for FSI. The probabilistic shaping scheme may implement or be implemented by aspects of the wireless communication system 100 or the signaling configuration 200. For example, a wireless device (e.g., a UE 115, a network entity 105) may perform probabilistic shaping for two or more subbands in accordance with the probabilistic shaping scheme 600. The wireless device may map a first subset of a first set of information bits associated with a subband 610 to a first subset of a first set of constellation points associated with a first modulation order and map a first subset of a second set of information bits associated with a subband 615 to a first subset of a second set of constellation points associated with a second modulation order. Additionally, the wireless device may map a second subset of the first set of information bits associated with the subband 610 to a second subset of the first set of constellation points and map a second subset of the second set of information bits associated with the subband 615 to a second subset of the second set of constellation points in accordance with one or more shaping parameters. The subband 610 may be associated with a first modulation order (e.g., with three amplitude bit levels 630-a, 630-b, and 630-c and a sign bit level 635) and the subband 615 may be associated with a second modulation order (e.g., with two amplitude bit levels 630-a and 630-b and a sign bit level 635).

In the probabilistic shaping scheme 600, the wireless device may use a single shaping block implementation (e.g., a single shaping block 240, as described with reference to FIG. 2) with a joint shaping parameter (e.g., to perform joint shaping across the subbands). For example, the wireless device may input first unshaped information bits (e.g., of length

$${K}_{1}^{′} )$$

into a DM 605 and not input or shape second unshaped information bits (e.g., of length K₂, where the first unshaped information bits and the second unshaped information bits correspond to a single TB). The DM 605 may be included in the shaping block 240 described with reference to FIG. 2, and the first and second unshaped information bits may be associated with the output of the demultiplexor block 235.

The DM 605 may shape the first unshaped information bits into first shaped information bits (e.g., of length

$${K}_{1}^{′} )$$

in accordance with the joint shaping parameter (e.g., associated with all modulation orders) and may not shape second unshaped information bits. In some examples, a performance of the DM 605 may increase based on shaping the first unshaped information bits jointly across all subbands (e.g., DM 605 performance may increase for relatively longer bit sequences). For example, the DM 605 may shape the first unshaped information bits in accordance with Equation 5 (e.g., in accordance with an MB distribution p(S)):

$$p ( S ) ∼ {e}^{- v {Σ}_{{k}_{2}} \frac{1}{{L}_{k} - L} {\sum }_{{u}_{k} ∈ \{ 0 , 1 \}} {L}_{k} - {L [ {f}^{( k )} ( S , {U}_{k} = {u}_{k} ) ]}^{2}} \qquad ( 5 )$$

where ƒ^{(k)} is a real modulation mapping function for a subband, k, that maps Lₖ bits (e.g., [b₁, b₂, . . . , b_{L}_{ₖ}] where ƒ^{(k)}: {0,1}^{L}^{ₖ} [symbol] {1, 3, 5, . . . 2^{L}^{ₖ}⁺¹−1}) to a positive real number or amplitude level, where S=(b₁, b₂, . . . , b_{L}) and is the sequence of L bits that are to be shaped in each subband, where Uₖ=(b_{L+1}, b_{L+2}, . . . , b_{L}_{ₖ}) and is the sequence of Lₖ-L bits that are not to be shaped (e.g., which may have uniform distribution) in a subband k, and where v is the joint shaping parameter. In some examples, the joint shaping parameter (e.g., v) of a probability mass function may be computed based on the condition H(S)=η, η∈[0, L]. Unshaped amplitude levels 630 and sign bit levels 635 may include at least one or more of unshaped systematic bits and parity bits.

The wireless device may input the first shaped information bits and the unshaped information bits into the FEC 620 (e.g., the FEC 255) to obtain a set 625 of first shaped information bits and one or more parity bits. In some examples, the set 625 may be input into an interleaver block (e.g., the interleaver block 260) and then a modulation block (e.g., a modulation block 265) to obtain a set of modulated symbols to be transmitted

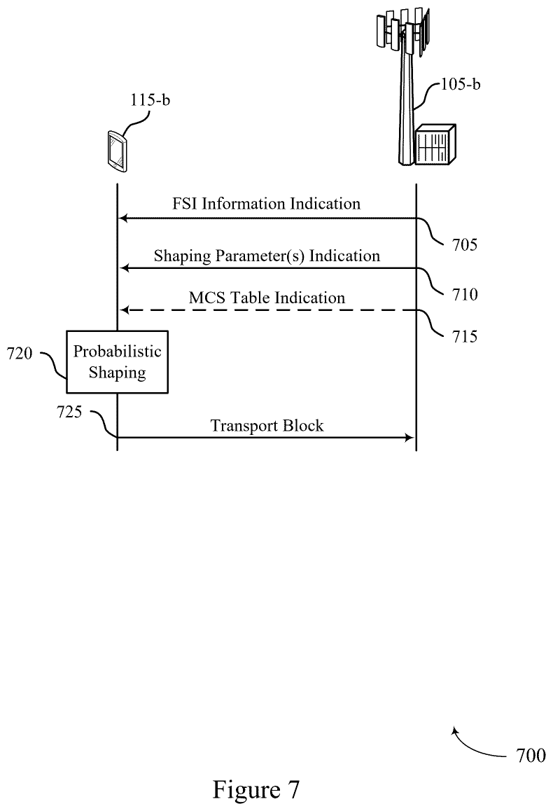

FIG. 7 shows an example of a process flow 700 that supports probabilistic shaping for FSI. The process flow 700 may implement or be implemented by aspects of any of the wireless communication system 100 or the signaling configuration 200. For example, the process flow 700 includes a network entity 105-b and a UE 115-b, which may be examples of corresponding devices described herein, including with reference to FIGS. 1-6. In the following description of the process flow 700, operations between the network entity 105-b and the UE 115-b may be added, omitted, or performed in a different order (e.g., relative to the order shown).

At 705, the network entity 105-b may transmit an indication of information for an integrated spectrum channel of a virtual cell, which may be received by the UE 115-b. The integrated spectrum channel may include a set of subbands that are formed by combining frequency resources from multiple frequency bands, where the set of subbands include at least a first subband associated with a first modulation order and a second subband associated with a second modulation order different from the first modulation order.

At 710, the network entity 105-b may transmit an indication of one or more shaping parameters that each correspond to a respective non-uniform distribution of a respective set of constellation points, which may be received by the UE 115-b. The one or more shaping parameters may be based on the first modulation order being different from the second modulation order. In some examples, the one or more shaping parameters may include a first shaping parameter associated with the first modulation order and a second shaping parameter associated with the second modulation order. The first shaping parameter may be different from the second shaping parameter based on the first modulation order being different from the second modulation order (e.g., as described further with reference to FIGS. 3 and 5). Is some other cases, the one or more shaping parameters may include a joint shaping parameter associated with the first modulation order and the second modulation order.

In some examples, at 715, the network entity 105-b may transmit an indication of an MCS table associated with the set of subbands, which may be received by the UE 115-b. The MCS table may include an indication of one or more associations between the first modulation order, the second modulation order, or both, and the one or more shaping parameters.

At 720, the UE 115-b may perform, in accordance with the one or more shaping parameters, probabilistic shaping to map a first set of information bits associated with the first subband to a first set of constellation points and to map a second set of information bits associated with the second subband to a second set of constellation points. The UE 115-b may map the first set of information bits associated with the first subband to the first set of constellation points and map the second set of information bits associated with the second subband to the second set of constellation points.

In some examples, the first set of constellation points may be associated with a first non-uniform distribution based on the first shaping parameter, and the second set of constellation points may be associated with a second non-uniform distribution based on the second shaping parameter, as described with reference to FIG. 3. In another example, the first set of constellation points may be associated with a first non-uniform distribution based on the first shaping parameter and a first modulation size of the first modulation order, and the second set of constellation points may be associated with a second non-uniform distribution based on the second shaping parameter and the first modulation size of the first modulation order. In such cases, the second non-uniform distribution may be based on the first modulation size of the first modulation order (e.g., rather than a second modulation size of the second modulation order) in accordance with the first modulation order being greater than the second modulation order, as described with reference to FIG. 5.

Additionally, or alternatively, as discussed herein, the one or more shaping parameters may include the joint shaping parameter associated with the first modulation order and the second modulation order. For example, the first set of constellation points may be associated with a first non-uniform distribution based on the joint shaping parameter and the first modulation order and the second set of constellation points may be associated with a second non-uniform distribution based on the joint shaping parameter and the second modulation order, as described with reference to FIG. 4. The joint shaping parameter may be based on an average entropy across the first subband and the second subband.

In some examples, the UE 115-b may map a first subset of the first set of information bits associated with the first subband to a first subset of the first set of constellation points associated with the first modulation order, where the first subset of the first set of constellation points may be associated with a non-uniform distribution in accordance with the joint shaping parameter, as described with reference to FIG. 6. The UE 115-b may map a second subset of the first set of information bits associated with the first subband to a second subset of the first set of constellation points, where the second subset of the first set of constellation points may be associated with a uniform distribution. Additionally, or alternatively, the UE 115-b may map a first subset of the second set of information bits associated with the second subband to a first subset of the second set of constellation points associated with the second modulation order, where the first subset of the second set of constellation points is associated with the non-uniform distribution in accordance with the joint shaping parameter. The UE 115-b may map a second subset of the second set of information bits associated with the second subband to a second subset of the second set of constellation points, and the second subset of the second set of constellation points may be associated with the uniform distribution. In some examples, the second subset of the first set of information bits and the second subset of the second set of information bits may each include one or more respective systemic bits, one or more respective parity bits, or a combination thereof.

At 725, the UE 115-b may transmit a single TB via the set of subbands in the integrated spectrum channel, which may be received by the network entity 105-b. By enabling the UE 115-b to perform probabilistic shaping for communications using an FSI approach, the described techniques may enable the UE 115-b to experience benefits of both the FSI approach and probabilistic shaping, such an increase in channel diversity and shaping gain for transmissions, among other examples.

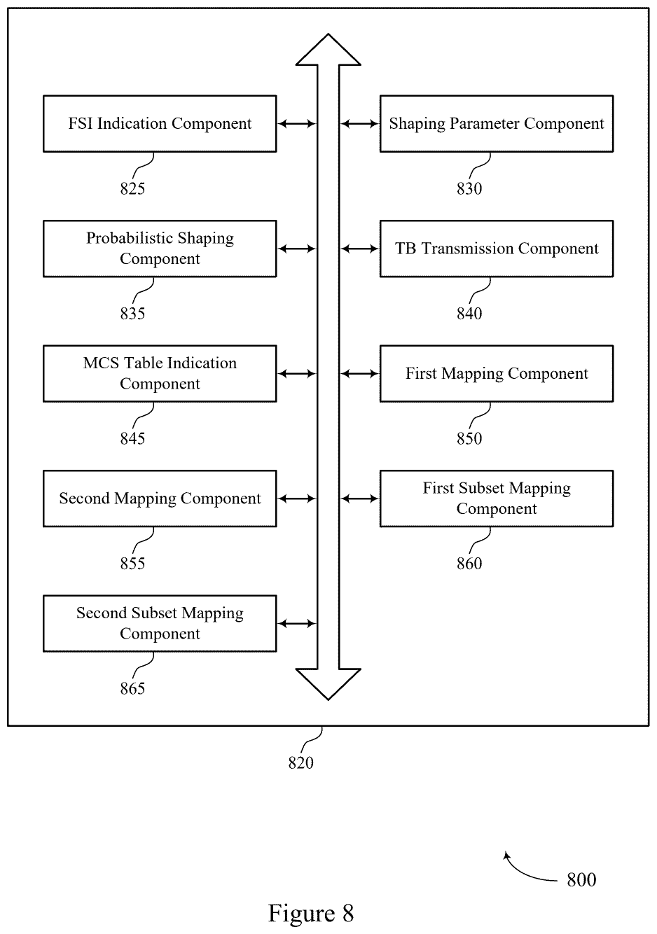

FIG. 8 shows an example of a processing system 820 that supports probabilistic shaping for FSI. A processing system 820 may be an example of a processing system 140 (such as of a UE 115) and may include an FSI indication component 825, a shaping parameter component 830, a probabilistic shaping component 835, a TB transmission component 840, an MCS table indication component 845, a first mapping component 850, a second mapping component 855, a first subset mapping component 860, a second subset mapping component 865, or any combination thereof. A processing system 820, or various component thereof, may be an example of means for performing (such as a means for causing a UE 115 to perform) various techniques described herein.

The FSI indication component 825 may be configured to cause the UE 115 to receive an indication of information for an integrated spectrum channel of a virtual cell, the integrated spectrum channel including a set of subbands that are formed by combining frequency resources from multiple frequency bands, where the set of subbands includes at least a first subband associated with a first modulation order and a second subband associated with a second modulation order different from the first modulation order. The shaping parameter component 830 may be configured to cause the UE 115 to receive an indication of one or more shaping parameters that each correspond to a respective non-uniform distribution of a respective set of constellation points, where the one or more shaping parameters are based on the first modulation order being different from the second modulation order. The probabilistic shaping component 835 may be configured to cause the UE 115 to perform, in accordance with the one or more shaping parameters, probabilistic shaping to map a first set of information bits associated with the first subband to a first set of constellation points and to map a second set of information bits associated with the second subband to a second set of constellation points. The TB transmission component 840 may be configured to cause the UE 115 to transmit, via the set of subbands in the integrated spectrum channel, a single transport block, the single transport block being generated based on the first set of information bits being mapped to the first set of constellation points and the second set of information bits being mapped to the second set of constellation points.

In some examples, to support receiving the indication of the one or more shaping parameters, the MCS table indication component 845 may be configured to cause the UE 115 to receive an indication of a modulation and coding scheme table associated with the set of subbands, where the modulation and coding scheme table includes an indication of one or more associations between the first modulation order, the second modulation order, or both, and the one or more shaping parameters.

In some examples, the one or more shaping parameters include a first shaping parameter associated with the first modulation order and a second shaping parameter associated with the second modulation order. In some examples, the first shaping parameter is different from the second shaping parameter based on the first modulation order being different from the second modulation order.

In some examples, to support performing the probabilistic shaping, the first mapping component 850 may be configured to cause the UE 115 to map the first set of information bits associated with the first subband to the first set of constellation points, where the first set of constellation points is associated with a first non-uniform distribution based on the first shaping parameter. In some examples, to support performing the probabilistic shaping, the second mapping component 855 may be configured to cause the UE 115 to map the second set of information bits associated with the second subband to the second set of constellation points, where the second set of constellation points is associated with a second non-uniform distribution based on the second shaping parameter.

In some examples, to support performing the probabilistic shaping, the first mapping component 850 may be configured to cause the UE 115 to map the first set of information bits associated with the first subband to the first set of constellation points, where the first set of constellation points is associated with a first non-uniform distribution based on the first shaping parameter and a first modulation size of the first modulation order. In some examples, to support performing the probabilistic shaping, the second mapping component 855 may be configured to cause the UE 115 to map the second set of information bits associated with the second subband to the second set of constellation points, where the second set of constellation points is associated with a second non-uniform distribution based on the second shaping parameter and the first modulation size of the first modulation order, and where the second non-uniform distribution is based on the first modulation size of the first modulation order in accordance with the first modulation order being larger than the second modulation order.

In some examples, the one or more shaping parameters include a joint shaping parameter associated with the first modulation order and the second modulation order. In some examples, to support performing the probabilistic shaping, the first mapping component 850 may be configured to cause the UE 115 to map the first set of information bits associated with the first subband to the first set of constellation points, where the first set of constellation points is associated with a first non-uniform distribution based on the joint shaping parameter and the first modulation order. In some examples, to support performing the probabilistic shaping, the second mapping component 855 may be configured to cause the UE 115 to map the second set of information bits associated with the second subband to the second set of constellation points, where the second set of constellation points is associated with a second non-uniform distribution based on the joint shaping parameter and the second modulation order. In some examples, the joint shaping parameter is based on an average entropy across the first subband and the second subband.

In some examples, to support performing the probabilistic shaping, the first subset mapping component 860 may be configured to cause the UE 115 to map a first subset of the first set of information bits associated with the first subband to a first subset of the first set of constellation points associated with the first modulation order, where the first subset of the first set of constellation points is associated with a non-uniform distribution in accordance with the joint shaping parameter. In some examples, to support performing the probabilistic shaping, the second subset mapping component 865 may be configured to cause the UE 115 to map a second subset of the first set of information bits associated with the first subband to a second subset of the first set of constellation points, where the second subset of the first set of constellation points is associated with a uniform distribution. Additionally, or alternatively, the first subset mapping component 860 may be configured to cause the UE 115 to map a first subset of the second set of information bits associated with the second subband to a first subset of the second set of constellation points associated with the second modulation order, where the first subset of the second set of constellation points is associated with the non-uniform distribution in accordance with the joint shaping parameter. In some examples, the second subset mapping component 865 may be configured to cause the UE 115 to map a second subset of the second set of information bits associated with the second subband to a second subset of the second set of constellation points, where the second subset of the second set of constellation points is associated with the uniform distribution. In some examples, the second subset of the first set of information bits and the second subset of the second set of information bits each include one or more respective systematic bits, one or more respective parity bits, or a combination thereof.

A processing system 820 may include or be a component of one or more chips, systems-on-chips (SoCs), chipsets, packages, components, or devices that individually or collectively constitute or include a processing system. A processing system 820 may interface with other components of a processing system 820. For example, operations described with reference to a processing system 820, or various components thereof, may be performed by or with other such components, including a receiver, a transmitter, a transceiver, a modem, a user interface, a modulator/demodulator, an encoder/decoder, or any combination thereof (such as of the processing system 820, coupled with the processing system 820, of a processing system 820).

By including or configuring a processing system 820 for operation in a processing system 820 as described herein, the processing system 820 may support techniques for more efficient utilization of communication resources, among other examples.

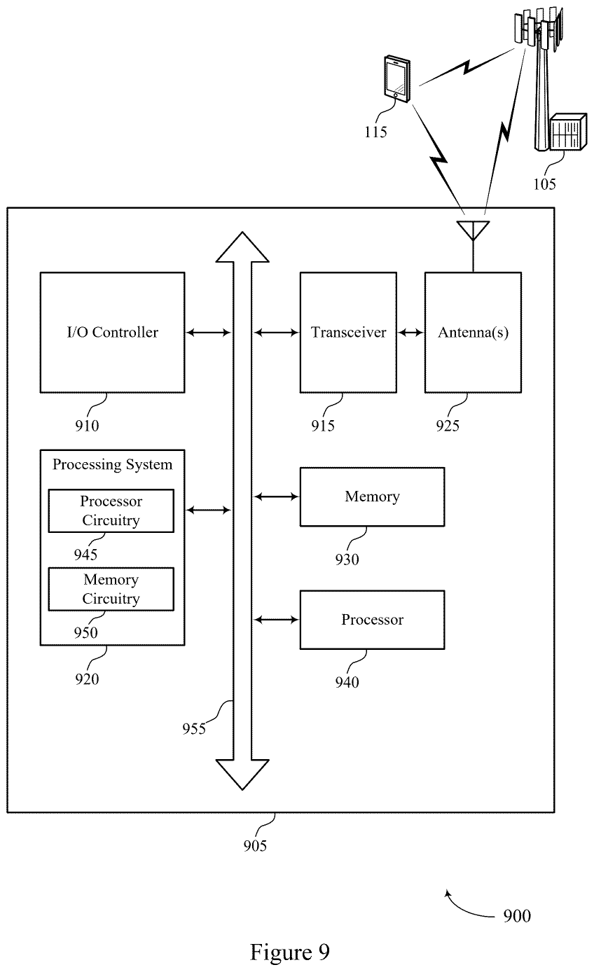

FIG. 9 shows an example of a system 900 including a device 905 that supports probabilistic shaping for FSI. The device 905 may be an example of or include components of UE 115. The device 905 may communicate (such as wirelessly) with one or more other devices (such as network entities 105, UEs 115). The device 905 may include components for transmitting and receiving communication, which may include a processing system 920, an input/output (I/O) controller, such as an I/O controller 910, a transceiver 915, antenna(s) 925, a memory 930, and a processor 940. Components of the device 905 may be coupled (such as operatively, communicatively, functionally, electronically, electrically, in electronic communication) a bus 955.

The transceiver 915 may support bi-directional communication via antenna(s) 925, and may support transmission operations, reception operations, or both, as described herein. The transceiver 915 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 905). The transceiver 915 may modulate symbols and provide the modulated symbols to antenna(s) 925 for transmission, and demodulate symbols from signals received using antenna(s) 925.

The processor 940 may be a general-purpose processing component that supports various operations (such as applications) of the device 905. The memory 930 may be a general-purpose storage component that stores code executable by the processor 940. Such code may include instructions that, when executed by the processor 940, cause the device 905 to perform various functions (such as to support an application of the device 905). The I/O controller 910 may manage inputs and outputs for the device 905, may manage peripherals not integrated into the device 905, or may represent a physical connection (such as port) to an external peripheral. The processor 940 may interact with a modem, a keyboard, a mouse, a touchscreen, or other device (such as via I/O controller 910). In some implementations, a user may interact with the device 905 via the I/O controller 910 or via hardware components controlled by the I/O controller 910.

The processing system 920 may be an example of a processing system 140 or a processing system 800. For example, the processing system 920 may include processor circuitry 945 and memory circuitry 950 that stores code, and may be configured to cause the device 905 to perform operations that support probabilistic shaping for FSI. Although the processing system 920 is illustrated as a separate component, which may involve a separate chip, chipset, or other module, in some implementations, one or more functions described with reference to the processing system 920 may be supported by or performed by a transceiver 915, antenna(s) 925, a processor 940, memory 930, or any combination thereof, such that a processing system 920 may include one or more of a transceiver 915, antenna(s) 925, a processor 940, memory 930, or any combination thereof.

By including or configuring the processing system 920 for operation in the device 905 as described herein, may support techniques for improved communication reliability, more efficient utilization of communication resources, improved coordination between devices, and improved utilization of processing capability, among other examples.

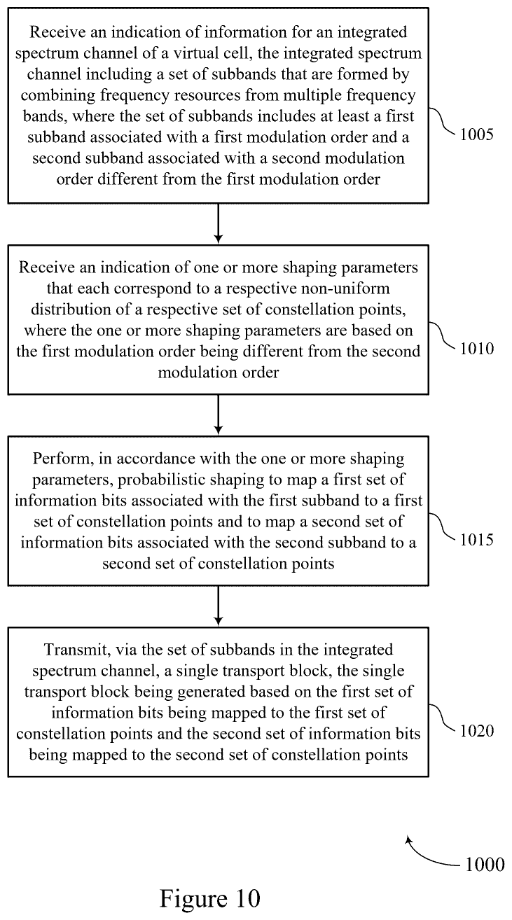

FIG. 10 shows an example of a method 1000 that supports probabilistic shaping for FSI. Operations of the method 1000 may be performed by a UE or its components (such as using a processing system configured to cause the UE 115 to perform one or more of the operations) as described herein.

At 1005, the method may include receiving an indication of information for an integrated spectrum channel of a virtual cell, the integrated spectrum channel including a set of subbands that are formed by combining frequency resources from multiple frequency bands, where the set of subbands includes at least a first subband associated with a first modulation order and a second subband associated with a second modulation order different from the first modulation order. In some examples, aspects of the operations of 1005 may be performed by an FSI indication component 825.

At 1010, the method may include receiving an indication of one or more shaping parameters that each correspond to a respective non-uniform distribution of a respective set of constellation points, where the one or more shaping parameters are based on the first modulation order being different from the second modulation order. In some examples, aspects of the operations of 1010 may be performed by a shaping parameter component 830.

At 1015, the method may include performing, in accordance with the one or more shaping parameters, probabilistic shaping to map a first set of information bits associated with the first subband to a first set of constellation points and to map a second set of information bits associated with the second subband to a second set of constellation points. In some examples, aspects of the operations of 1015 may be performed by a probabilistic shaping component 835.

At 1020, the method may include transmitting, via the set of subbands in the integrated spectrum channel, a single transport block, the single transport block being generated based on the first set of information bits being mapped to the first set of constellation points and the second set of information bits being mapped to the second set of constellation points. In some examples, aspects of the operations of 1020 may be performed by a TB transmission component 840.

Implementation examples are described in the following numbered clauses:

Aspect 1: A method for wireless communications at a wireless device, comprising: receiving an indication of information for an integrated spectrum channel of a virtual cell, the integrated spectrum channel comprising a set of subbands that are formed by combining frequency resources from multiple frequency bands, wherein the set of subbands comprises at least a first subband associated with a first modulation order and a second subband associated with a second modulation order different from the first modulation order; receiving an indication of one or more shaping parameters that each correspond to a respective non-uniform distribution of a respective set of constellation points, wherein the one or more shaping parameters are based at least in part on the first modulation order being different from the second modulation order; performing, in accordance with the one or more shaping parameters, probabilistic shaping to map a first set of information bits associated with the first subband to a first set of constellation points and to map a second set of information bits associated with the second subband to a second set of constellation points; and transmitting, via the set of subbands in the integrated spectrum channel, a single transport block, the single transport block being generated based at least in part on the first set of information bits being mapped to the first set of constellation points and the second set of information bits being mapped to the second set of constellation points.

Aspect 2: The method of aspect 1, wherein receiving the indication of the one or more shaping parameters comprises: receiving an indication of a modulation and coding scheme table associated with the set of subbands, wherein the modulation and coding scheme table comprises an indication of one or more associations between the first modulation order, the second modulation order, or both, and the one or more shaping parameters.

Aspect 3: The method of any of aspects 1 through 2, wherein the one or more shaping parameters comprise a first shaping parameter associated with the first modulation order and a second shaping parameter associated with the second modulation order, the first shaping parameter is different from the second shaping parameter based at least in part on the first modulation order being different from the second modulation order.

Aspect 4: The method of aspect 3, wherein performing the probabilistic shaping comprises: mapping the first set of information bits associated with the first subband to the first set of constellation points, wherein the first set of constellation points is associated with a first non-uniform distribution based at least in part on the first shaping parameter; and mapping the second set of information bits associated with the second subband to the second set of constellation points, wherein the second set of constellation points is associated with a second non-uniform distribution based at least in part on the second shaping parameter.

Aspect 5: The method of any of aspects 3 through 4, wherein performing the probabilistic shaping comprises: mapping the first set of information bits associated with the first subband to the first set of constellation points, wherein the first set of constellation points is associated with a first non-uniform distribution based at least in part on the first shaping parameter and a first modulation size of the first modulation order; and mapping the second set of information bits associated with the second subband to the second set of constellation points, wherein the second set of constellation points is associated with a second non-uniform distribution based at least in part on the second shaping parameter and the first modulation size of the first modulation order, and wherein the second non-uniform distribution is based at least in part on the first modulation size of the first modulation order in accordance with the first modulation order being larger than the second modulation order.

Aspect 6: The method of any of aspects 1 through 5, wherein the one or more shaping parameters comprise a joint shaping parameter associated with the first modulation order and the second modulation order.

Aspect 7: The method of aspect 6, wherein performing the probabilistic shaping comprises: mapping the first set of information bits associated with the first subband to the first set of constellation points, wherein the first set of constellation points is associated with a first non-uniform distribution based at least in part on the joint shaping parameter and the first modulation order; and mapping the second set of information bits associated with the second subband to the second set of constellation points, wherein the second set of constellation points is associated with a second non-uniform distribution based at least in part on the joint shaping parameter and the second modulation order.

Aspect 8: The method of any of aspects 6 through 7, wherein the joint shaping parameter is based at least in part on an average entropy across the first subband and the second subband.

Aspect 9: The method of any of aspects 6 through 8, wherein performing the probabilistic shaping comprises: mapping a first subset of the first set of information bits associated with the first subband to a first subset of the first set of constellation points associated with the first modulation order, wherein the first subset of the first set of constellation points is associated with a non-uniform distribution in accordance with the joint shaping parameter; mapping a second subset of the first set of information bits associated with the first subband to a second subset of the first set of constellation points, wherein the second subset of the first set of constellation points is associated with a uniform distribution; mapping a first subset of the second set of information bits associated with the second subband to a first subset of the second set of constellation points associated with the second modulation order, wherein the first subset of the second set of constellation points is associated with the non-uniform distribution in accordance with the joint shaping parameter; and mapping a second subset of the second set of information bits associated with the second subband to a second subset of the second set of constellation points, wherein the second subset of the second set of constellation points is associated with the uniform distribution.

Aspect 10: The method of aspect 9, wherein the second subset of the first set of information bits and the second subset of the second set of information bits each comprise one or more respective systematic bits, one or more respective parity bits, or a combination thereof.

Aspect 11: A wireless device for wireless communications, comprising a processing system that includes processor circuitry and memory circuitry that stores code, the processing system configured to cause the wireless device to perform a method of any of aspects 1 through 10.

Aspect 12: A wireless device for wireless communications, comprising at least one means for performing a method of any of aspects 1 through 10.

Aspect 13: A non-transitory computer-readable medium storing code for wireless communications, the code comprising instructions executable by one or more processors to perform a method of any of aspects 1 through 10.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components or actions, among other examples. The phrase “associated with” may be interpreted to mean or be interchanged with “in association with,” “in accordance with,” “based on,” “based at least in part on,” “as a function of,” “in response to,” “responsive to,” “using,” “coupled with,” in communication with,” “configured with,” “included with,” or “in cooperation with,” as appropriate in the relevant context unless otherwise explicitly indicated. Additionally, the use of such phrases does not indicate that what follows the phrase is the focal point or primary factor associated with the limitation preceding the phrase.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
a processing system that includes processor circuitry and memory circuitry that stores code, the processing system configured to cause the wireless device to:
receive an indication of information for an integrated spectrum channel of a virtual cell, the integrated spectrum channel comprising a set of subbands that are formed by combining frequency resources from multiple frequency bands, wherein the set of subbands comprises at least a first subband associated with a first modulation order and a second subband associated with a second modulation order different from the first modulation order;
receive an indication of one or more shaping parameters that each correspond to a respective non-uniform distribution of a respective set of constellation points, wherein the one or more shaping parameters are based at least in part on the first modulation order being different from the second modulation order;
perform, in accordance with the one or more shaping parameters, probabilistic shaping to map a first set of information bits associated with the first subband to a first set of constellation points and to map a second set of information bits associated with the second subband to a second set of constellation points; and
transmit, via the set of subbands in the integrated spectrum channel, a single transport block, the single transport block being generated based at least in part on the first set of information bits being mapped to the first set of constellation points and the second set of information bits being mapped to the second set of constellation points.

2. The wireless device of claim 1, wherein, to receive the indication of the one or more shaping parameters, the processing system is configured to cause the wireless device to:
receive an indication of a modulation and coding scheme table associated with the set of subbands, wherein the modulation and coding scheme table comprises an indication of one or more associations between the first modulation order, the second modulation order, or both, and the one or more shaping parameters.

3. The wireless device of claim 1, wherein:
the one or more shaping parameters comprise a first shaping parameter associated with the first modulation order and a second shaping parameter associated with the second modulation order, and
the first shaping parameter is different from the second shaping parameter based at least in part on the first modulation order being different from the second modulation order.

4. The wireless device of claim 3, wherein, to perform the probabilistic shaping, the processing system is configured to cause the wireless device to:
map the first set of information bits associated with the first subband to the first set of constellation points, wherein the first set of constellation points is associated with a first non-uniform distribution based at least in part on the first shaping parameter; and
map the second set of information bits associated with the second subband to the second set of constellation points, wherein the second set of constellation points is associated with a second non-uniform distribution based at least in part on the second shaping parameter.

5. The wireless device of claim 3, wherein, to perform the probabilistic shaping, the processing system is configured to cause the wireless device to:
map the first set of information bits associated with the first subband to the first set of constellation points, wherein the first set of constellation points is associated with a first non-uniform distribution based at least in part on the first shaping parameter and a first modulation size of the first modulation order; and
map the second set of information bits associated with the second subband to the second set of constellation points, wherein the second set of constellation points is associated with a second non-uniform distribution based at least in part on the second shaping parameter and the first modulation size of the first modulation order, and wherein the second non-uniform distribution is based at least in part on the first modulation size of the first modulation order in accordance with the first modulation order being larger than the second modulation order.

6. The wireless device of claim 1, wherein the one or more shaping parameters comprise a joint shaping parameter associated with the first modulation order and the second modulation order.

7. The wireless device of claim 6, wherein, to perform the probabilistic shaping, the processing system is configured to cause the wireless device to:
map the first set of information bits associated with the first subband to the first set of constellation points, wherein the first set of constellation points is associated with a first non-uniform distribution based at least in part on the joint shaping parameter and the first modulation order; and
map the second set of information bits associated with the second subband to the second set of constellation points, wherein the second set of constellation points is associated with a second non-uniform distribution based at least in part on the joint shaping parameter and the second modulation order.

8. The wireless device of claim 6, wherein the joint shaping parameter is based at least in part on an average entropy across the first subband and the second subband.

9. The wireless device of claim 6, wherein, to perform the probabilistic shaping, the processing system is configured to cause the wireless device to:
map a first subset of the first set of information bits associated with the first subband to a first subset of the first set of constellation points associated with the first modulation order, wherein the first subset of the first set of constellation points is associated with a non-uniform distribution in accordance with the joint shaping parameter;
map a second subset of the first set of information bits associated with the first subband to a second subset of the first set of constellation points, wherein the second subset of the first set of constellation points is associated with a uniform distribution;
map a first subset of the second set of information bits associated with the second subband to a first subset of the second set of constellation points associated with the second modulation order, wherein the first subset of the second set of constellation points is associated with the non-uniform distribution in accordance with the joint shaping parameter; and
map a second subset of the second set of information bits associated with the second subband to a second subset of the second set of constellation points, wherein the second subset of the second set of constellation points is associated with the uniform distribution.

10. The wireless device of claim 9, wherein the second subset of the first set of information bits and the second subset of the second set of information bits each comprise one or more respective systematic bits, one or more respective parity bits, or a combination thereof.

11. A method for wireless communications at a wireless device, comprising:
receiving an indication of information for an integrated spectrum channel of a virtual cell, the integrated spectrum channel comprising a set of subbands that are formed by combining frequency resources from multiple frequency bands, wherein the set of subbands comprises at least a first subband associated with a first modulation order and a second subband associated with a second modulation order different from the first modulation order;
receiving an indication of one or more shaping parameters that each correspond to a respective non-uniform distribution of a respective set of constellation points, wherein the one or more shaping parameters are based at least in part on the first modulation order being different from the second modulation order;
performing, in accordance with the one or more shaping parameters, probabilistic shaping to map a first set of information bits associated with the first subband to a first set of constellation points and to map a second set of information bits associated with the second subband to a second set of constellation points; and
transmitting, via the set of subbands in the integrated spectrum channel, a single transport block, the single transport block being generated based at least in part on the first set of information bits being mapped to the first set of constellation points and the second set of information bits being mapped to the second set of constellation points.

12. The method of claim 11, wherein receiving the indication of the one or more shaping parameters comprises:
receiving an indication of a modulation and coding scheme table associated with the set of subbands, wherein the modulation and coding scheme table comprises an indication of one or more associations between the first modulation order, the second modulation order, or both, and the one or more shaping parameters.

13. The method of claim 11, wherein:
the one or more shaping parameters comprise a first shaping parameter associated with the first modulation order and a second shaping parameter associated with the second modulation order, and
the first shaping parameter is different from the second shaping parameter based at least in part on the first modulation order being different from the second modulation order.

14. The method of claim 13, wherein performing the probabilistic shaping comprises:
mapping the first set of information bits associated with the first subband to the first set of constellation points, wherein the first set of constellation points is associated with a first non-uniform distribution based at least in part on the first shaping parameter; and
mapping the second set of information bits associated with the second subband to the second set of constellation points, wherein the second set of constellation points is associated with a second non-uniform distribution based at least in part on the second shaping parameter.

15. The method of claim 13, wherein the second modulation order is set equal to the first modulation order based at least in part on the first modulation order being greater than the second modulation order, and wherein performing the probabilistic shaping comprises:
mapping the first set of information bits associated with the first subband to the first set of constellation points, wherein the first set of constellation points is associated with a first non-uniform distribution based at least in part on the first shaping parameter and the first modulation order; and
mapping the second set of information bits associated with the second subband to the second set of constellation points, wherein the second set of constellation points is associated with a second non-uniform distribution based at least in part on the second shaping parameter and the first modulation order and based at least in part on the second modulation order being set equal to the first modulation order.

16. The method of claim 11, wherein the one or more shaping parameters comprise a joint shaping parameter associated with the first modulation order and the second modulation order.

17. The method of claim 16, wherein performing the probabilistic shaping comprises:
mapping the first set of information bits associated with the first subband to the first set of constellation points, wherein the first set of constellation points is associated with a first non-uniform distribution based at least in part on the joint shaping parameter and the first modulation order; and
mapping the second set of information bits associated with the second subband to the second set of constellation points, wherein the second set of constellation points is associated with a second non-uniform distribution based at least in part on the joint shaping parameter and the second modulation order.

18. The method of claim 16, wherein the joint shaping parameter is based at least in part on an average entropy across the first subband and the second subband.

19. The method of claim 16, wherein performing the probabilistic shaping comprises:
mapping a first subset of the first set of information bits associated with the first subband to a first subset of the first set of constellation points associated with the first modulation order, wherein the first subset of the first set of constellation points is associated with a non-uniform distribution in accordance with the joint shaping parameter;
mapping a second subset of the first set of information bits associated with the first subband to a second subset of the first set of constellation points, wherein the second subset of the first set of constellation points is associated with a uniform distribution;
mapping a first subset of the second set of information bits associated with the second subband to a first subset of the second set of constellation points associated with the second modulation order, wherein the first subset of the second set of constellation points is associated with the non-uniform distribution in accordance with the joint shaping parameter; and
mapping a second subset of the second set of information bits associated with the second subband to a second subset of the second set of constellation points, wherein the second subset of the second set of constellation points is associated with the uniform distribution.

20. A non-transitory computer-readable medium storing code for wireless communications, the code comprising instructions executable by one or more processors to:
receive an indication of information for an integrated spectrum channel of a virtual cell, the integrated spectrum channel comprising a set of subbands that are formed by combining frequency resources from multiple frequency bands, wherein the set of subbands comprises at least a first subband associated with a first modulation order and a second subband associated with a second modulation order different from the first modulation order;
receive an indication of one or more shaping parameters that each correspond to a respective non-uniform distribution of a respective set of constellation points, wherein the one or more shaping parameters are based at least in part on the first modulation order being different from the second modulation order;
perform, in accordance with the one or more shaping parameters, probabilistic shaping to map a first set of information bits associated with the first subband to a first set of constellation points and to map a second set of information bits associated with the second subband to a second set of constellation points; and
transmit, via the set of subbands in the integrated spectrum channel, a single transport block, the single transport block being generated based at least in part on the first set of information bits being mapped to the first set of constellation points and the second set of information bits being mapped to the second set of constellation points.
